(19) United States
(12) Patent Application Publication
(10) Pub. No.: US 2009/0083849 A1
(43) Pub. Date: Mar. 26, 2009

(54) SECURITY PROTECTION METHOD AND PORTABLE ELECTRONIC DEVICE USING SAME

(75) Inventors: SHIH-FANG WONG, Tu-Cheng (TW); YI-FENG WENG, Shenzhen City (CN); BING LI, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/176,421

(22) Filed: Jul. 21, 2008

(30) Foreign Application Priority Data
Sep. 21, 2007 (CN) 200710201823.0

(51) Int. Cl. G06F 21/00

(52) U.S. Cl. 726/18

(57) ABSTRACT

A security protection method used in a portable electronic device is provided. The portable electronic device provides an ID table for recording IDs of external electronic devices that are allowed to access the portable electronic device. The method includes: obtaining an ID of an external electronic device when the external electronic device is connected to the portable electronic device; determining whether the obtained ID exists in the ID table; and allowing the connected external electronic device to access the portable electronic device when the obtained ID exists in the ID table. A portable electronic device used the method is also provided.

### BACKGROUND

1. Technical Field

The present invention relates to a security protection method and portable storage device using the method.

2. General Background

Portable storage devices are used to transfer data between computing devices or other devices. For example, Universal Serial Bus (USB) memory sticks, USB flash memory devices, USB flash memory cards, and other portable devices are often used to transfer data between computing devices or other devices. These portable storage devices offer great convenience to users, allowing the users to easily transfer data between devices.

Often times, the data stored on a portable storage device need to be protected in some way. For example, the data may need to be protected because of privacy concerns, corporate security concerns, or copyright reasons. There is a password protection solution that has been implemented on the portable storage device for security protection. The portable storage device typically provides the user with a prompt when the user attempts to access the protected data. The user must then provide the password to unlock data access prevention software resident in the portable storage device if the password entered matches an originally provided password.

Once the password verification procedure is completed successfully, the user can access to the protected data. When having entered an incorrect password, the user is denied access, thereby preventing unauthorized access to the portable storage device. However, even if a user is an owner of the portable storage device and tries to use his or her own computing device to access the portable storage device, he or she still has to enter the password every time. This practice is apparent to be time consuming and burdensome to the owner-user.

What is needed, therefore, is an improved portable storage device and security protection method that can effectively protect unauthorized access to the portable storage device.

### SUMMARY

A security protection method used in a portable electronic device is provided. The portable electronic device provides an identifier table for recording IDs of external electronic devices, which are allowed to access the portable electronic device. The method includes: (a) obtaining an ID of an external electronic device when the external electronic device is connected to the portable electronic device; (b) determining whether the obtained ID exists in the ID table; and (c) allowing the connected external electronic device to access the portable electronic device when the obtained ID exists in the ID table.

Other advantages and novel features will be drawn from the following detailed description with reference to the attached drawings.

### BRIEF DESCRIPTION OF THE DRAWINGS

The components of the drawings are not necessarily drawn to measuring scale, the emphasis instead being placed upon clearly illustrating the principles of the portable electronic device with a security protection function. Moreover, in the drawings, like reference numerals designate corresponding parts throughout the several views.

FIG. 1 is a block diagram of a hardware infrastructure of a portable electronic device with a security protection function according to an exemplary embodiment of the present invention.

FIG. 2 is a block diagram of main function modules of an identifying module of the portable electronic device of FIG. 1.

FIG. 3 is a flowchart of a security protection method implemented by the portable electronic device of FIG. 1 according to an exemplary embodiment of the present invention.

### DETAILED DESCRIPTION OF THE EMBODIMENTS

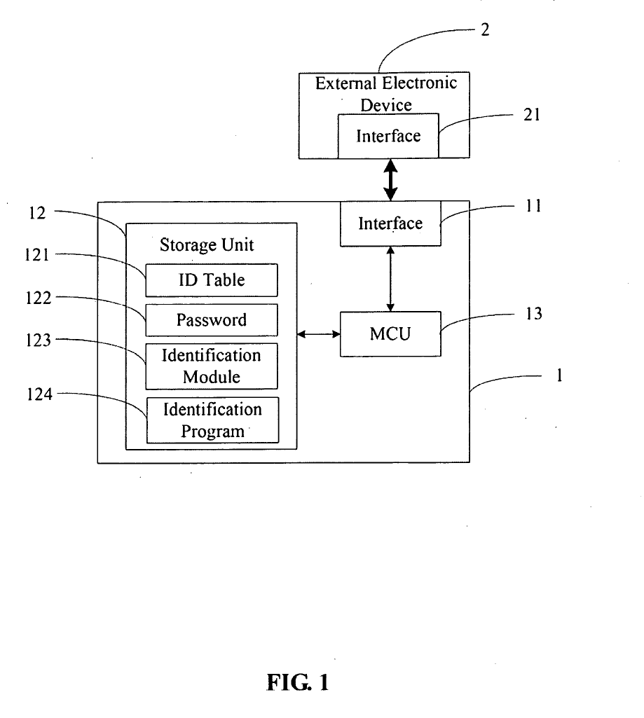

FIG. 1 is a block diagram of a hardware infrastructure of a portable electronic device with a security protection function (hereinafter, “the device”) according to an exemplary embodiment of the present invention. The device 1 is typically a storage device, such as a memory card. The device 1 includes an interface 11, a storage unit 12, and a micro-program control unit (MCU) 13. The interface 11 is configured for enabling the device 1 to communicate data with external electronic devices 2. The interface 11 can be, but not limited to, a wireless interface such as BLUETOOTH or ZIGBEE interface, or a wired interface such as a universal serial bus (USB) interface, or a firewire interface. The MCU 13 is with microinstructions and is configured for executing the microinstructions to make the interface 11 performing specific functions, such as reading and writing data from/to the storage unit 12.

The storage unit 12 stores an identifier (ID) table 121, a predetermined password 122, an identification module 123, and an identification program 124. The ID table records IDs of external electronic devices 2 which are allowed to access the device 1. The identification module 1 23 is run according to the identification program 124.

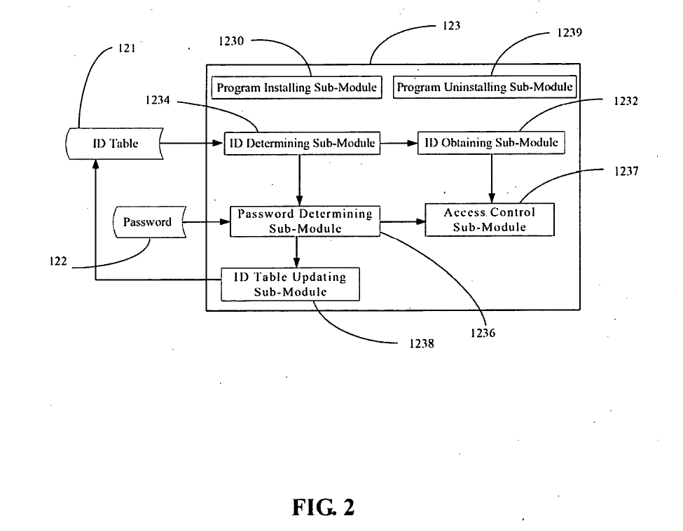

Referring to FIG. 2, the identification module 123 includes a program installing sub-module 1230, an ID obtaining sub-module 1232, an ID determining sub-module 1234, a password determining sub-module 1236, an access control sub-module 1237, an ID table updating sub-module 1238, and a program uninstalling sub-module 1239.

The program installing sub-module 1230 is configured for automatically installing the identification program 124 on the external electronic device 2 when the external electronic device 2 is connected to the device 1.

The ID obtaining sub-module 1232 is configured for obtaining the ID of the connected external electronic device 2.

The ID determining sub-module 1234 is configured for determining whether the obtained ID exists in the ID table 121. If the obtained ID exists in the ID table 121, the ID determining sub-module 1234 generates a first signal to the access control sub-module 1237. If the obtained ID does not exist in the ID table 121, the ID determining sub-module 1234 generates a second signal to the access control sub-module 1237.

The access control sub-module 1237 is configured for controlling the connected external electronic device 2 to access the device 1 according to the signal from the ID determining sub-module 1234. Typically, when receiving the first signal, the access control sub-module 1237 allows the connected external electronic device 2 to access the device 1. For example, the access control sub-module 1237 allows the connected external electronic device 2 to read and/or write data from/to the device 1. When receiving the second signal, the access control sub-module 1237 prohibits the connected external electronic device 2 from accessing the device 1.

In addition, in another exemplary embodiment of the present invention, if the obtained ID does not exist in the ID table 121, the ID determining sub-module 1234 generates the second signal to the password determining sub-module 1236.

The password determining sub-module 1236 is configured for generating a password dialogue diagram for receiving a password input from a user, and determining whether the input password matches the predetermined password 122. If the input password matches the predetermined password 122, the password determining sub-module 1236 generates a third signal to the access control sub-module 1237. The access control sub-module 1237 allows the connected external electronic device 2 to access the device 1 according to the third signal. If the input password does not match the predetermined password 122, the password determining sub-module 1236 generates a fourth signal to the access control sub-module 1237. The access control sub-module 1237 prohibits the connected external electronic device 2 from accessing the device 1 according to the fourth signal.

In addition, if the input password matches the predetermined password 122, the password determining sub-module 1236 further sends the third signal to the ID table updating sub-module 1238.

The ID table updating sub-module 1238 is configured for generating an ID dialogue diagram for inquiring the user whether to add the obtained ID of the current connected external electronic device 2 to the ID table 121 according to the third signal. For example, the ID dialogue diagram provides a “YES” item and a “NO” item for selection. If receiving an input on the “YES” item, the ID table updating sub-module 1238 adds the obtained ID to the ID table 121. If receiving an input on the “NO” item, the ID table updating sub-module 1238 does not add the obtained ID to the ID table 121.

The program uninstalling sub-module 1239 is configured for automatically uninstalling the identification program 124 from the connected external electronic device 2 when the external electronic device 2 is being disconnected with the device 2.

In addition, in another embodiment, the identification module 123 does not include the program uninstalling sub-module 1239. In such situation, the program installing sub-module 1230 does not need to install the identification program 124 again in the external electronic device 2 when the external electronic device 2 is, not for the first time, connected to the device 1.

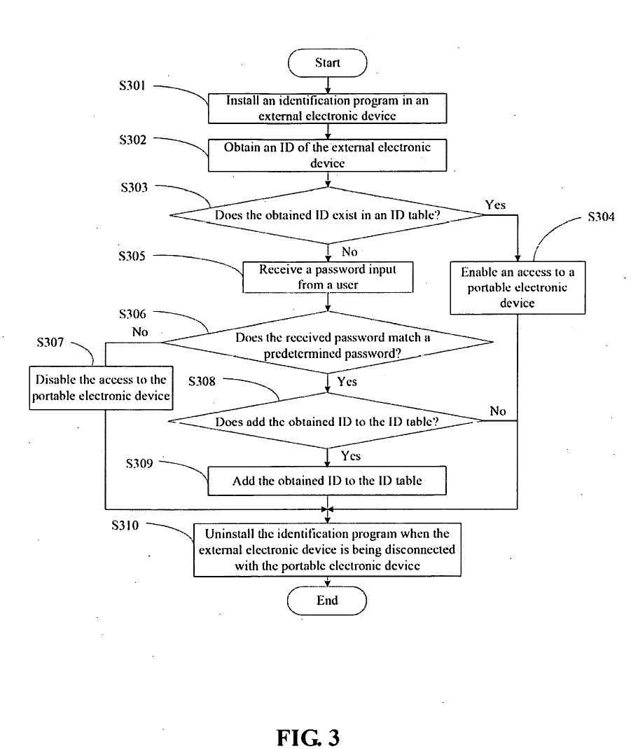

FIG. 3 is a flowchart of a security protection method implemented by the device 1 according to an exemplary embodiment of the present invention. In step S301, the program installing sub-module 1230 installs the identification program 124 on the connected external electronic device 2 when external electronic device 2 is connected to the device 1.

In step S302, the ID obtaining sub-module 1232 obtains the ID of the connected external electronic device 2.

In step S303, the ID determining sub-module 1234 determines whether the obtained ID exists in the ID table 121.

If the obtained ID exists in the ID table 121, in step S304, the access control sub-module 1237 allows the connected external electronic device 2 to access the device 1.

If the obtained ID does not exist in the ID table 121, in step S305, the password determining sub-module 1236 generates the password dialogue diagram to receive the password from the user.

In step S306, the password determining sub-module 1236 determines whether the input password matches the predetermined password 122.

If the input password does not match the predetermined password 122, in step S307, the access control sub-module 1238 prohibits the connected external electronic device 2 from accessing the device 1, and the procedure goes to step S310 described later.

If the input password matches the predetermined password 122, in step S308, the ID table updating sub-module 1238 generates the ID dialogue diagram for inquiring the user whether to add the obtained ID of the current connected external electronic device 2 to the ID table 121. If receiving the input on the “NO” item, namely where the user does not want to add the ID to the ID table 121, the procedure goes to step S304 described above.

If receiving the input on the “YES” item, namely where the user wants to add the ID to the ID table 121, in step S309, the ID table updating sub-module 1238 adds the obtained ID to the ID table 121.

In step S310, the program uninstalling sub-module 1239 uninstalls the identification program 124 from the external electronic device 2 when the external electronic device 2 is being disconnected with the device 1.

Although the present invention has been specifically described on the basis of exemplary embodiments, the invention is not to be construed as being limited thereto. Various changes or modifications may be made to the embodiments without departing from the scope and spirit of the invention.

What is claimed is:

1. A portable electronic device with a security protection function, comprising:
a storage unit for storing an identification program and an identifier (ID) table, wherein the ID table is configured for recording IDs of external electronic devices which are allowed to access the portable electronic device; and
an identifying module configured for being operated based on the identification program, comprising:
a program installing sub-module configured for automatically installing the identification program on an external electronic device when the external electronic device is connected to the portable electronic device;
an ID obtaining sub-module configured for obtaining an ID of the connected external electronic device;
an ID determining sub-module configured for determining whether the obtained ID exists in the ID table; and
an access control sub-module configured for allowing the connected external electronic device to access the portable electronic device when the obtained ID exists in the ID table.

2. The device according to claim 1, wherein the access control sub-module prohibits the connected external electronic device from accessing the portable electronic device when the obtained ID does not exists in the ID table.

3. The device according to claim 1, wherein the identifying module further comprises a password determining sub-module configured for determining whether a password input from a user matches a predetermined password stored in the storage unit, wherein the access control sub-module further allows the connected external electronic device to access the portable electronic device when the password input matches the predetermined password, and prohibits the connected external electronic device from accessing the portable electronic device when the password input does not match the predetermined password.

4. The device according to claim 3, wherein the identifying module further comprises an ID table updating sub-module configured for adding the obtained ID to the ID table when the password input matches the predetermined password.

5. The device according to claim 1, wherein the identifying module further comprises a program uninstalling sub-module configured for automatically uninstalling the identification program from the connected external electronic device when the external electronic device is being disconnected with the portable electronic device.

6. A security protection method used in a portable electronic device, wherein the portable electronic device provides an identifier (ID) table for recording IDs of external electronic devices which are allowable to access the portable electronic device, the method comprising:
obtaining an ID of an external electronic device when the external electronic device is connected to the portable electronic device;
determining whether the obtained ID exists in the ID table; and
allowing the connected external electronic device to access the portable electronic device when the obtained ID exists in the ID table.

7. The method according to claim 6, further comprising prohibiting the connected external electronic device from accessing the portable electronic device when the obtained ID does not exist in the ID table.

8. The method according to claim 6, further comprising receiving a password input from a user when the obtained ID does not exist in the ID table; allowing the connected external electronic device to access the portable electronic device when the password input matches a predetermined password; and prohibiting the connected external electronic device from accessing the portable electronic device when the password input does not match the predetermined password.

9. The method according to claim 8, further comprising adding the obtained ID to the ID table when the password input matches the predetermined password.

10. The method according to claim 9, further comprising installing an identification program in the connected electronic device.

11. The method according to claim 10, further comprising uninstalling an identification program from the connected electronic device when the electronic device is being disconnected.
